(19) United States
(12) Patent Application Publication
(10) Pub. No.: US 2024/0303767 A1
(43) Pub. Date: Sep. 12, 2024

(54) ELECTRONIC DEVICE AND CONTROLLING METHOD TO SELECT SCALER BASED ON IMAGE CHARACTERISTICS

(71) Applicant: Samsung Electronics Co., Ltd., Suwon-si (KR)

(72) Inventors: Junhyuk LEE, Suwon-si (KR); Hyoungsup KIM, Suwon-si (KR); Hyunbin PARK, Suwon-si (KR); Seungjin YANG, Suwon-si (KR); Kwangman OK, Suwon-si (KR); Jin CHOI, Suwon-si (KR); Boyeon NA, Suwon-si (KR)

(21) Appl. No.: 18/518,850

(22) Filed: Nov. 24, 2023

Related U.S. Application Data
(63) Continuation of application No. PCT/KR2023/017003, filed on Oct. 30, 2023.

(30) Foreign Application Priority Data
Mar. 7, 2023 (KR) 10-2023-0030159
Mar. 29, 2023 (KR) 10-2023-0041545

(51) Int. Cl. G06T 3/40; G06T 3/00; G06T 7/11

(52) U.S. Cl. CPC G06T 3/40; G06T 3/10; G06T 7/11; G06T 2200/28; G06T 2207/20021; G06T 2207/20084; G09G 3/20; G09G 2340/0407

(57) ABSTRACT

An electronic device and control method for selecting a scaler based on image characteristics are provided. The electronic device includes at least one processor, a display, and a plurality of scalers including a first scaler and a second scaler. The at least one processor generates a first temporary upscaling image of an image by using an algorithm of the first scaler and generate a second temporary up scaling image of the image by using an algorithm of the second scaler. The at least one processor identifies a difference value of a pixel between the first temporary upscaling image and the second temporary upscaling image. The at least one processor selects one scaler based on the identified difference value and a preconfigured threshold value. The at least one processor upscales the image and controls the display to display the upscaled image.

### CROSS-REFERENCE TO RELATED APPLICATION(S)

This application is a continuation application, claiming priority under § 365(c), of an International application No. PCT/KR2023/017003, filed on Oct. 30, 2023, which is based on and claims the benefit of a Korean patent application number 10-2023-0030159, filed on Mar. 7, 2023, in the Korean Intellectual Property Office, and of a Korean patent application number 10-2023-0041545, filed on Mar. 29, 2023, in the Korean Intellectual Property Office, the disclosure of each of which is incorporated by reference herein in its entirety.

### TECHNICAL FIELD

The disclosure relates to an electronic device and a control method. More particularly, the disclosure relates to an electronic device and a control method for selecting one of a plurality of scalers in consideration of characteristics of an image.

### BACKGROUND ART

An electronic device may obtain (or receive) an image and display the obtained image. The resolution of the obtained image may vary. The electronic device may process images of various resolutions with a resolution supported by the electronic device and display the processed images. The resolution supported by the electronic device may include a plurality of types. The electronic device may convert the obtained image into images of various resolutions by using a single scaler. Alternatively, the electronic device may include a plurality of scalers and convert the obtained image by using a scaler corresponding to a resolution to be converted.

The above information is presented as background information only to assist with an understanding of the disclosure. No determination has been made, and no assertion is made, as to whether any of the above might be applicable as prior art with regard to the disclosure.

### DISCLOSURE OF INVENTION

Aspects of the disclosure are to address at least the above-mentioned problems and/or disadvantages and to provide at least the advantages described below. Accordingly, an aspect of the disclosure is to provide an electronic device and a control method for converting an image by selecting an appropriate scaler according to the image.

Additional aspects will be set forth in part in the description which follows and, in part, will be apparent from the description, or may be learned by practice of the presented embodiments.

In accordance with an aspect of the disclosure, an electronic device is provided. The electronic device includes at least one processor, a display, and a plurality of scalers including a first scaler and a second scaler. The at least one processor may generate a first temporary upscaling image of an image by using an algorithm of the first scaler that converts an image into an image with a preconfigured high-definition resolution. The at least one processor may generate a second temporary upscaling image of the image by using an algorithm of the second scaler. The at least one processor may identify a difference value of a pixel between the first temporary upscaling image and the second temporary upscaling image. The at least one processor may select one of the first scaler and the second scaler based on the identified difference value and a preconfigured threshold value. The at least one processor may upscale the image by using the selected one scaler. The at least one processor may control the display to display the upscaled image.

The at least one processor may divide the first temporary upscaling image and the second temporary upscaling image into preconfigured areas, and identify a difference value between a pixel included in the divided area of the first temporary upscaling image and a corresponding pixel included in the divided area of the second temporary upscaling image.

The at least one processor may identify the difference values in all the divided areas, identify an average value of the identified difference values, select the first scaler when the identified average value is greater than or equal to a preconfigured first threshold value, and select the second scaler when the identified average value is less than the preconfigured first threshold value.

The at least one processor may identify the difference values in all the divided areas, identify a preconfigured number of difference values in descending order among the identified difference values, identify sum of the identified preconfigured number of difference values, select the first scaler when the identified sum is greater than or equal to a preconfigured second threshold value, and select the second scaler when the identified sum is less than the preconfigured second threshold value.

The at least one processor may identify the difference values in all the divided areas, select the first scaler when the largest difference value among the identified difference values is greater than or equal to a preconfigured third threshold value, and select the second scaler when the largest difference value is less than the preconfigured third threshold value.

The at least one processor may include at least one of a central processing unit, a neural network processing unit, and a graphics processing unit, and generate the first temporary upscaling image and the second temporary upscaling image by using the graphics processing unit when the usage amount of the graphics processing unit is less than a preconfigured value.

The at least one processor may generate the first temporary upscaling image and the second temporary up scaling image by using the neural network processing unit when the usage amount of the graphics processing unit exceeds the preconfigured value.

The at least one processor may generate the first temporary upscaling image and the second temporary upscaling image by using the central processing unit when the central processing unit includes a data processing acceleration function.

The at least one processor may upscale the image to a preconfigured high-definition resolution image by using the first scaler when the first scaler is selected, deliver the upscaled image and resolution information of the upscaled image to the display, and control the display to display the delivered upscaled image based on the upscaled resolution information.

The at least one processor may deliver the image and resolution information of the image to be upscaled to the display when the second scaler is selected, upscale the image by using the second scaler based on the resolution information of the image to be upscaled, and control the display to display the upscaled image.

The first scaler may be included in the processor, and the second scaler may be included in a display driver integrated circuit (IC) (DDI) that drives the display.

In accordance with another aspect of the disclosure, a control method of an electronic device is provided. The control method includes generating a first temporary upscaling image of an image by using an algorithm of the first scaler that converts an image into an image with a preconfigured high-definition resolution, and generating a second temporary upscaling image of the image by using an algorithm of the second scaler. The control method may include identifying a difference value of a pixel between the first temporary upscaling image and the second temporary upscaling image. The control method may include selecting one of the first scaler and the second scaler based on the identified difference value and a preconfigured threshold value. The control method may include upscaling the image by using the selected one scaler. The control method may include displaying the upscaled image.

The identifying a difference value of a pixel may divide the first temporary upscaling image and the second temporary upscaling image into preconfigured areas, and identify a difference value between a pixel included in the divided area of the first temporary upscaling image and a corresponding pixel included in the divided area of the second temporary upscaling image.

The selecting one scaler may identify the difference values in all the divided areas, identify an average value of the identified difference values, select the first scaler when the identified average value is greater than or equal to a preconfigured first threshold value and select the second scaler when the identified average value is less than the preconfigured first threshold value.

The selecting one scaler may identify the difference values in all the divided areas, identify a preconfigured number of difference values in descending order among the identified difference values, identify sum of the identified preconfigured number of difference values, select the first scaler when the identified sum is greater than or equal to a preconfigured second threshold value and select the second scaler when the identified sum is less than the preconfigured second threshold value.

The selecting one scaler may identify the difference values in all the divided areas, select the first scaler when the largest difference value among the identified difference values is greater than or equal to a preconfigured third threshold value, and select the second scaler when the largest difference value is less than the preconfigured third threshold value.

The generating process may generate the first temporary upscaling image and the second temporary upscaling image by using the graphics processing unit when the usage amount of the graphics processing unit is less than a preconfigured value among at least one of a central processing unit, a neural network processing unit, and a graphics processing unit included in at least one processor.

The generating process may generate the first temporary upscaling image and the second temporary upscaling image by using the neural network processing unit when the usage amount of the graphics processing unit exceeds the preconfigured value.

The generating process may generate the first temporary upscaling image and the second temporary upscaling image by using the central processing unit when the central processing unit includes a data processing acceleration function.

The upscaling the image may upscale the image to a preconfigured high-definition resolution image by using the first scaler when the first scaler is selected, and deliver the upscaled image and resolution information of the upscaled image to the display, and the displaying process may display the delivered upscaled image based on the upscaled resolution information.

The upscaling the image may deliver the image and resolution information of the image to be upscaled to the display when the second scaler is selected, and upscale the image by using the second scaler based on the resolution information of the image to be upscaled, and the displaying process may display the upscaled image by using the second scaler.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a block diagram illustrating a configuration of an electronic device according to an embodiment of the disclosure;

FIG. 3 is a block diagram illustrating a configuration related to an operation of a scaler according to an embodiment of the disclosure;

FIG. 4 is a flowchart illustrating a control method of an electronic device according to an embodiment of the disclosure;

FIG. 5 is a diagram illustrating a process of selecting a scaler considering characteristics of an image according to an embodiment of the disclosure;

FIG. 6 is a diagram illustrating a process of selecting one scaler from among a plurality of scalers according to an embodiment of the disclosure;

FIG. 7 is a flowchart illustrating a process of selecting a scaler according to an embodiment of the disclosure; and

FIG. 8 is a diagram illustrating a process of selecting a scaler by using a trained neural network model according to an embodiment of the disclosure.

Throughout the drawings, it should be noted that like reference numbers are used to depict the same or similar elements, features, and structures.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

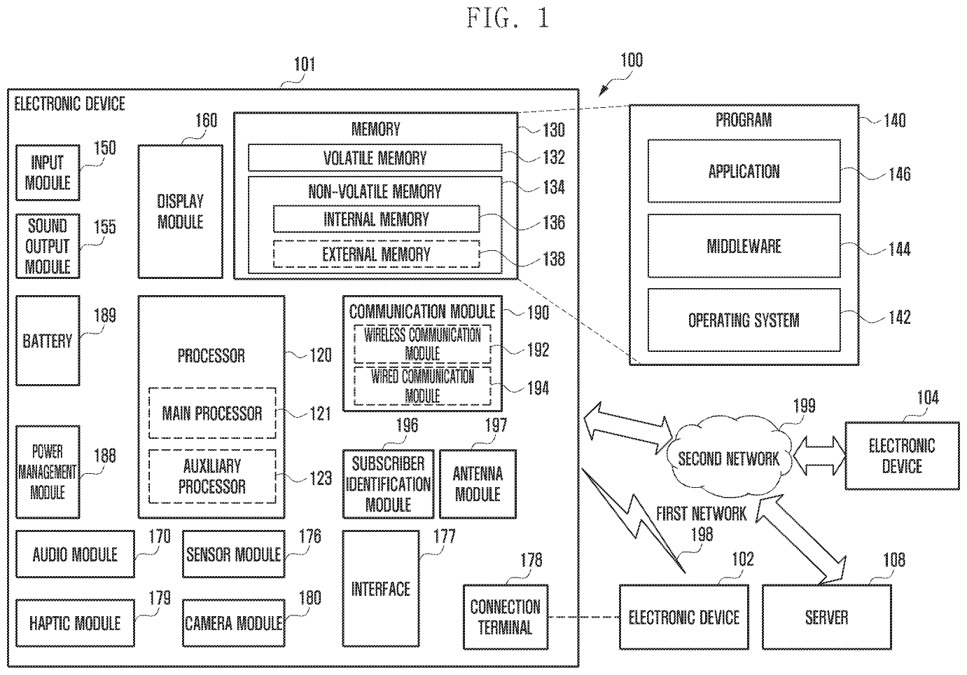

FIG. 1 is a block diagram illustrating an electronic device in a network environment according to an embodiment of the disclosure.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory may include at least one of an internal memory 136 and an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., the electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 gigabits per second (Gbps) or more) for implementing eMBB, loss coverage (e.g., 164 decibels (dB) or less) for implementing mMTC, or U-plane latency (e.g., 0.5 milliseconds (ms) or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form an mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices (e.g. electronic devices 102 and 104 or the server 108). For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra-low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

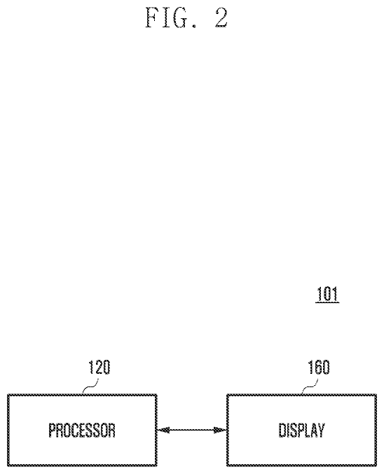

FIG. 2 is a block diagram illustrating a configuration of an electronic device according to an embodiment of the disclosure.

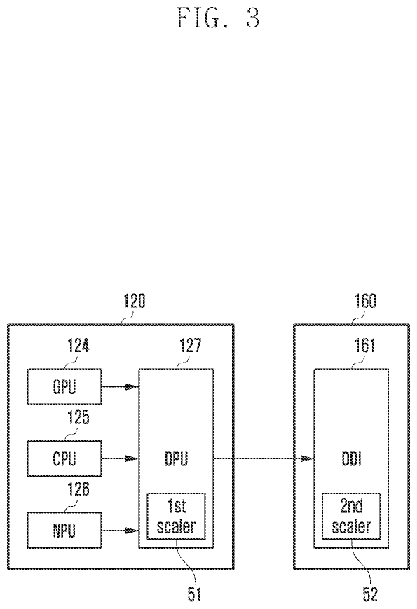

FIG. 3 is a block diagram illustrating a configuration related to an operation of a scaler according to an embodiment of the disclosure. The followings will be described with reference to FIGS. 2 and 3 together.

Referring to FIG. 2, the electronic device 101 may include a processor 120 and a display 160. Referring to FIG. 3, the processor 120 may include a graphics processing unit (GPU) 124, a central processing unit (CPU) 125, a neural processing unit (NPU) 126, and a data processing unit (DPU) 127, and the display 160 may include a display driver IC (DDI) 161. The GPU 124 may be referred to as a graphics processing module, the CPU 125 may be referred to as a central processing module, the NPU 126 may be referred to as a neural network processing module, and the DPU 127 may be referred to as a data processing module.

The processor 120 may control each component of the electronic device 101. The electronic device 101 may include one or more processors 120. The DPU 127 of the processor 120 may include a first scaler 51. The first scaler 51 may convert an image into an image with a preconfigured high-definition resolution, and may be a hardware scaler. For example, the preconfigured high-definition resolution includes Quad High Definition (QHD), QHD+, Wide Quad High Definition (WQHD), WQHD+, Ultra High Definition (UHD), UHD+, and Full Ultra High Definition (FUHD). As an embodiment, the first scaler 51 may be an Application Processor (AP) scaler, and the AP scaler may convert an image into a WQHD+resolution image.

The display 160 may output data processed by the processor 120 as an image. The DDI 161 of the display 160 may include a second scaler 52. For example, the second scaler 52 converts an image into an image of a lower quality than the image converted by the first scaler 51 and may be a hardware scaler. As an embodiment, the second scaler 52 may be a bilinear scaler, and the bilinear scaler may convert an image into an image such as Full High Definition (FHD)+ resolution. Because the bilinear scaler is included in the DDI 161, it may also be referred to as a DDI scaler. For example, the display 160 is implemented as at least one of a Liquid Crystal Display (LCD), an Organic Light Emitting Diode (OLED), a flexible display, or a touch screen display. When the display 160 is implemented as a touch screen display, the electronic device 101 may receive a user input through the display 160.

According to an embodiment, in the disclosure, an embodiment in which the first scaler 51 is included in the DPU 127 and the second scaler 52 is included in the DDI 161 is mainly described, but at least one of the number or location of a plurality of scalers is not limited thereto. For example, the electronic device 101 further includes a third scaler (not illustrated) in the DPU 127. Alternatively, at least of the first scaler 51 or the second scaler 52 may be included in locations different from those illustrated, but the electronic device 101 may operate substantially the same as the operation according to the embodiment of the disclosure.

The processor 120 may generate a first temporary upscaling image and a second temporary upscaling image. As an embodiment, the processor 120 may execute instructions related to the scaling algorithm of the AP scaler and the scaling algorithm of the bilinear scaler. The processor 120 may generate a temporary upscaling image with a high-definition resolution by using the scaling algorithm of the AP scaler and a temporary upscaling image with a low-definition resolution by using the scaling algorithm of the bilinear scaler. For example, the processor 120 simulates a scaling process in software by using a plurality of scaling algorithms before converting an image into an output image by using a hardware scaler. For example, the processor 120 generates a first temporary upscaling image of an image by using the algorithm of the first scaler 51 and a second temporary upscaling image of the image by using the algorithm of the second scaler 52.

For example, the processor 120 (e.g., the CPU 125) determines a processing unit to generate a temporary upscaling image according to the usage amount of the GPU 124 and whether the CPU 125 supports a data processing acceleration function. As an example, the CPU 125 may support the data processing acceleration function by including an ARM SCALABLE MATRIX EXTENSION module. If the usage amount of the GPU 124 is less than a preconfigured value, the processor 120 may determine the GPU 124 as a module to generate a temporary upscaling image. For example, the usage amount of the GPU 124 is the resource occupancy rate of the GPU 124, and for example, the preconfigured value is configured to 70%, but those skilled in the art will easily understand that the numerical value of the value is not limited. In this case, when the resource occupancy rate of the GPU 124 is less than 70%, the processor 120 may determine the GPU 124 as a module to generate a temporary upscaling image. The GPU 124 may generate a first temporary upscaling image by using the algorithm of the first scaler 51 and a second temporary upscaling image by using the algorithm of the second scaler 52. The first temporary upscaling image and the second temporary upscaling image may be images scaled-up by a software method.

When the usage amount of the GPU 124 is greater than or equal to the preconfigured value, the processor 120 may determine the CPU 125 or the NPU 126 as a module to generate an upscaling image. For example, the CPU 125 includes the data processing acceleration function. When the CPU 125 includes the data processing acceleration function or is active, the processor 120 may determine the CPU 125 as a module to generate an upscaling image. The CPU 125 may generate a first temporary upscaling image by using the algorithm of the first scaler 51 and a second temporary upscaling image by using an algorithm of the second scaler 52. Alternatively, when the CPU 125 does not include the data processing acceleration function or is in an inactive state, the processor 120 may determine the NPU 126 as a module to generate an upscaling image. The NPU 126 may generate the first temporary upscaling image by using the algorithm of the first scaler 51 and the second temporary upscaling image by using the algorithm of the second scaler 52.

The processor 120 may identify difference values of pixels between the generated first temporary upscaling image and the second temporary upscaling image. For example, the processor 120 divides the first temporary upscaling image and the second temporary upscaling image in the same way. For example, the processor 120 divides areas of the first temporary upscaling image and the second temporary upscaling image in the same way. The size and resolution of the first temporary upscaling image and the generated second temporary upscaling image may be the same. Accordingly, the size of the area of the first temporary upscaling image and the size of the area of the second temporary upscaling image may be the same. In addition, the location of each area of the first temporary upscaling image may correspond to the location of each area of the second temporary upscaling image. The processor 120 may obtain pixel values for each divided area of the first temporary upscaling image. In addition, the processor 120 may obtain pixel values for each divided area of the second temporary upscaling image in the same manner. In addition, the processor 120 may obtain the pixel value difference value for each divided area of the first temporary upscaling image and the second temporary upscaling image.

For example, when the first areas of the first temporary upscaling image and the second temporary upscaling image include 100 pixels, the processor 120 obtains difference values between corresponding pixels. For example, the processor 120 obtains a difference value between the first pixels, a difference value between the second pixels, . . . , and a difference value between the 100th pixels. The difference value between each pixel may be a difference value for each of the R component, the G component, and the B component. For example, the processor 120 obtains a statistical value (e.g., a sum value or an average value) of difference values for each of the R component, the G component, and the B component as the pixel difference value. Alternatively, the processor 120 may obtain a value of each component of another color model, such as a Gray model, a hue, saturation, and value (HSV) model, or a brightness (luma), blue difference, and red difference (YCbCr) model, or a statistical value of a brightness value as a pixel difference value. The processor 120 may identify the statistical value of difference values of 100 pixels as the difference value of the first area.

The processor 120 may determine one scaler among a plurality of hardware scalers based on the difference value of the area and the preconfigured threshold value. The processor 120 may select the first scaler 51 when the difference value is greater than or equal to the threshold value, and select the second scaler 52 when the difference value is less than the threshold value. For example, when the threshold value is 0.3 and the area difference value is 0.5, the processor 120 determines the first scaler 51. Alternatively, when the threshold value is 0.3 and the area difference value is 0.2, the processor 120 may determine the second scaler 52. The threshold value may be configured by a user based on the pixel value difference of the upscaled image, and the like according to the image characteristics and the scaler. Alternatively, the threshold value may be dynamically configured by using a neural network model trained from an input image.

The processor 120 may upscale an image based on the determined scaler. For example, the processor 120 determines the first scaler (e.g., an AP scaler) 51 included in the DPU 127 as a scaler to perform the upscaling process, and control the DPU 127. The DPU 127 may upscale the image to an image with a preconfigured high-definition resolution (e.g., WQHD+) by using the first scaler 51. In addition, the DPU 127 may deliver the upscaled image and resolution information to the DDI 161 of the display 160. The DDI 161 may display the upscaling image on the display panel based on the resolution information. Alternatively, the processor 120 may determine the second scaler (e.g., a DDI scaler) 52 included in the DDI 161 of the display 160 as a scaler to perform the upscaling process. The processor 120 may deliver an unscaled image (e.g., an original image) and resolution information to the DDI 161 of the display 160 through the DPU 127. In addition, the processor 120 may control the DDI 161 to change the resolution of the delivered image. The DDI 161 may upscale the delivered image to an image of a preconfigured resolution (e.g., FHD+) by using the second scaler 52 and display the upscaled image on the display panel.

Images in the disclosure may include still images and dynamic images. When the image is a dynamic image, the processor 120 may upscale each frame (or scene) included in the dynamic image through the above-described process and display the upscaled image on the display 160.

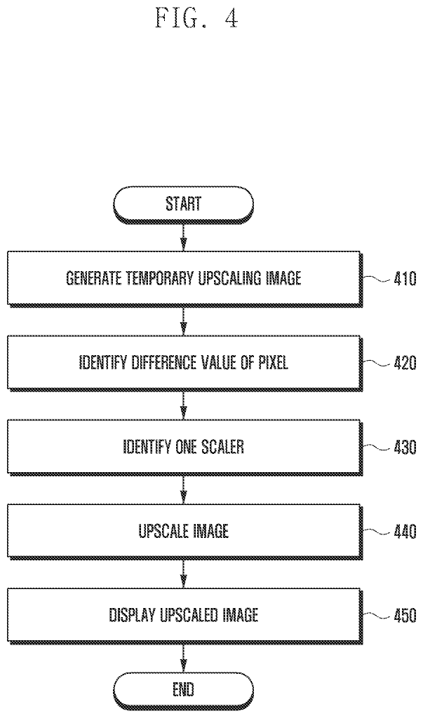

FIG. 4 is a flowchart illustrating a control method of an electronic device according to an embodiment of the disclosure.

Referring to FIG. 4, the electronic device 101 may generate a temporary upscaling image in operation 410. The electronic device 101 may generate a first temporary upscaling image of the image by using an algorithm of a first scaler and a second temporary upscaling image of the image by using an algorithm of a second scaler. For example, the algorithm of the first scaler is an algorithm for converting an image with a preconfigured high-definition resolution, and the algorithm of the second scaler is an algorithm for converting an image with a resolution lower than that of the first scaler algorithm. As an embodiment, the first scaler may be an AP scaler, and the preconfigured high-definition resolution may be WQHD+. The second scaler may be a DDI scaler, and a relatively low-definition resolution may be FHD+. The first temporary upscaling image and the second temporary upscaling image may be images upscaled by a software method.

The electronic device 101 may include at least one module of a central processing module (CPU) (e.g., the CPU 125 of FIG. 3), a neural network processing module (NPU) (e.g., the NPU 126 of FIG. 3), and a graphics processing module (GPU) (e.g., the GPU 124 of FIG. 3). The electronic device 101 may select a module to upscale an image in software based on the usage amount of the graphics processing module. For example, when the usage amount of the graphics processing module is less than a preconfigured value, the electronic device 101 generates the first temporary upscaling image and the second temporary upscaling image by using the graphics processing module. When the usage amount of the graphics processing module is greater than or equal to the preconfigured value, the electronic device 101 may generate the first temporary upscaling image and the second temporary upscaling image by using the neural network processing module. Alternatively, the electronic device 101 may determine whether the central processing module includes a data processing acceleration function or whether the data processing acceleration function is activated. When the central processing module includes the data processing acceleration function or the data processing acceleration function is activated, the electronic device 101 may generate the first temporary upscaling image and the second temporary upscaling image by using the central processing module.

The electronic device 101 may identify difference values of pixels between a plurality of temporary up scaling images in operation 420. For example, the electronic device 101 divides the first temporary upscaling image and the second temporary upscaling image into preconfigured areas. The divided areas of the first temporary upscaling image may correspond to the divided areas of the second temporary upscaling image. The electronic device 101 may obtain difference values of pixels for each divided area. In addition, the electronic device 101 may obtain the average value of the difference values of the obtained pixels as difference values of the areas.

The electronic device 101 may identify one scaler based on the difference values of the obtained areas and the preconfigured threshold value in operation 430, and upscale the image based on the identified scaler in operation 440. For example, the electronic device 101 may obtain the average value of difference values of all areas. The electronic device 101 may select the first scaler when the obtained average value is greater than or equal to the preconfigured threshold value, and may select the second scaler when the obtained average value is less than the preconfigured threshold value. Alternatively, the electronic device 101 may arrange the difference values of all areas in descending order, and obtain a sum value obtained by summing the difference values of the preconfigured number of areas starting with the area having the largest difference value. The electronic device 101 may select the first scaler when the obtained sum value is greater than or equal to the preconfigured threshold value, and may select the second scaler when the obtained sum value is less than or equal to the preconfigured threshold value. Alternatively, the electronic device 101 may obtain the largest difference value among difference values of all areas. The electronic device 101 may select the first scaler when the largest difference value is greater than or equal to the preconfigured threshold value, and select the second scaler when the largest difference value is less than the preconfigured threshold value. For example, the first scaler is a scaler implemented as a hardware in the DPU, and the second scaler may be a scaler implemented as a hardware in the DDI. Threshold values according to each criterion may be different values.

When the first scaler is selected, the electronic device 101 may upscale the image with the first hardware scaler included in the DPU. Alternatively, when the second scaler is selected, the electronic device 101 may deliver images and resolution information to the DDI through the DPU. In addition, the electronic device 101 may upscale the image with the second hardware scaler included in the DDI.

The electronic device 101 may display the upscaled image in operation 450. When the first scaler is selected, the electronic device 101 may deliver the image upscaled by the first scaler and resolution information to the display 160, and display the upscaled image on the display 160 based on the delivered resolution information. Alternatively, when the second scaler is selected, the electronic device 101 may display the image upscaled by the second scaler on the display 160.

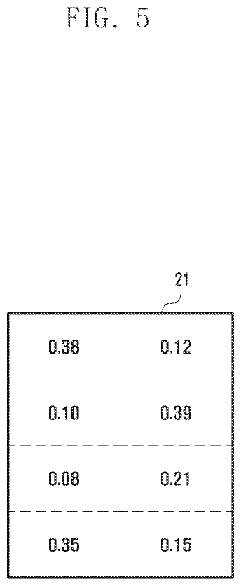

FIG. 5 is a diagram illustrating a process of selecting a scaler considering characteristics of an image according to an embodiment of the disclosure.

Referring to FIG. 5, an image 21 including difference values for each area is illustrated. The electronic device 101 may divide the first temporary upscaling image and the second temporary upscaling image into a plurality of areas. In addition, the electronic device 101 may obtain difference values of all pixels included in each area. The electronic device 101 may obtain an average value of difference values of all pixels as a difference value of the area.

As an embodiment, the electronic device 101 may divide the first and second temporary upscaling images into 8 areas, and obtain a difference value of each area based on a pixel difference value of the first and second temporary upscaling images. As illustrated in FIG. 5, the electronic device 101 may obtain difference values of 0.38 for the first area, 0.12 for the second area, 0.10 for the third area, 0.39 for the fourth area, 0.08 for the fifth area, 0.21 for the sixth area, 0.35 for the seventh area, and 0.15 for the eighth area. The electronic device 101 may determine a scaler to upscale the image based on the difference value of the area and the threshold value.

The electronic device 101 may determine the scaler based on the average value of difference values of all areas. In the above example, the average value of the difference values of the image 21 including the difference values for each area is 0.2225. When the threshold value is 0.2, the electronic device 101 may select the first scaler. When the threshold value is 0.3, the electronic device 101 may select the second scaler. Alternatively, the electronic device 101 may determine the scaler based on a preconfigured number of difference values in descending order. In the above example, the preconfigured number may be 3. The three areas in descending order from the area with the largest difference value are the fourth area (0.39), the first area (0.38), and the seventh area (0.35), and the sum of the difference values of the three areas is 1.12. When the threshold value is 1, the electronic device 101 may select the first scaler. When the threshold value is 1.3, the electronic device 101 may select the second scaler. Alternatively, the electronic device 101 may determine the scaler based on the largest difference value. In the above example, the largest difference value is 0.39 (fourth area). When the threshold value is 0.3, the electronic device 101 may select the first scaler. When the threshold value is 0.5, the electronic device 101 may select the second scaler.

The fact that the pixel difference value (or area difference value) between upscaled images is large may refer to that the difference between upscaled images in each scaler is large, and may refer to that the original image includes many visually distinguishable features. As an embodiment, an image with many sharp outlines or an image including text may have a large difference in upscaling results depending on the performance or resolution of the scaler, and may have a large pixel difference value between upscaling images. Accordingly, the electronic device 101 may improve the quality of the upscaling image by selecting a scaler for upscaling to a high-definition resolution based on the threshold value.

On the other hand, the fact that the pixel difference value (or area difference value) between upscaled images is small may refer to that the difference between upscaled images in each scaler is small, and may refer to that there are not many characteristic parts in the original image. As an embodiment, a blur image may have a small difference between upscaling results and a small pixel difference value between upscaling images according to the performance or resolution of the scaler. Accordingly, the electronic device 101 may reduce power consumption by selecting a scaler that upscales to a relatively low-definition resolution based on the threshold value. In addition, because the electronic device 101 obtains a pixel difference value by dividing the content into areas, it is possible to determine whether the characteristic content located only in a specific area exists.

So far, an example in which the electronic device 101 includes two scalers has been described, but the electronic device 101 may include three or more scalers.

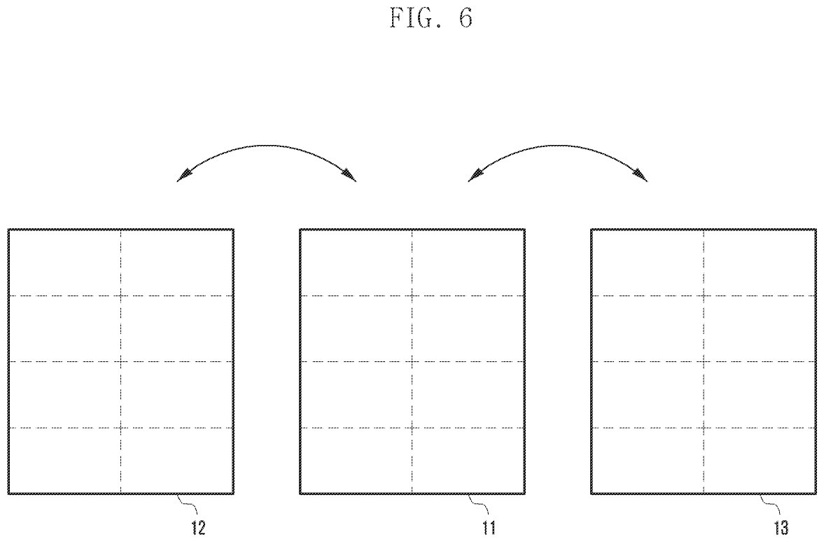

FIG. 6 is a diagram illustrating a process of selecting one scaler from among a plurality of scalers according to an embodiment of the disclosure.

Referring to FIG. 6, a first temporary upscaling image 11, a second temporary upscaling image 12, and a third temporary upscaling image 13 generated by each algorithm of three scalers are illustrated. The first temporary upscaling image 11 may be an image generated by a first scaler algorithm, and the first scaler may be an AP scaler. The second temporary upscaling image 12 may be an image generated by a second scaler algorithm, and the second scaler may be a DDI scaler. The third temporary upscaling image 13 may be an image generated by a third scaler algorithm, and the third scaler may be an artificial intelligence (AI) scaler, an application processor (AP) 1 scaler, or an AP2 scaler. For example, the AP1 scaler to the APn scaler refers to a scaler included in the AP, and is classified into AP1 to APn according to supported resolutions. The third scaler may be a scaler for upscaling to a higher resolution image than the first scaler. The third scaler may also be included in the DPU.

As described in FIG. 3, the electronic device 101 may divide (or classify) the second temporary upscaling image 12 and the first temporary upscaling image 11 into a plurality of areas, and obtain a difference between pixel values of each area. In addition, the electronic device 101 may select one scaler by comparing the reference value and the threshold value. For example, the reference value includes the average value of difference values of all areas, the sum of difference values of a predetermined number of areas from the area having the largest difference value, or the largest difference value among difference values of all areas. When the reference value is less than the first threshold value, the electronic device 101 may select the second scaler. When the reference value is greater than or equal to the first threshold value, the electronic device 101 may exclude the second scaler and compare the first temporary upscaling image 11 and the third temporary upscaling image 13. When the reference value is less than the second threshold value, the electronic device 101 may select the first scaler. When the reference value is greater than or equal to the second threshold, the electronic device 101 may select the third scaler. In FIG. 6, an example in which the electronic device 101 includes three scalers has been described, but the electronic device 101 may include four or more scalers.

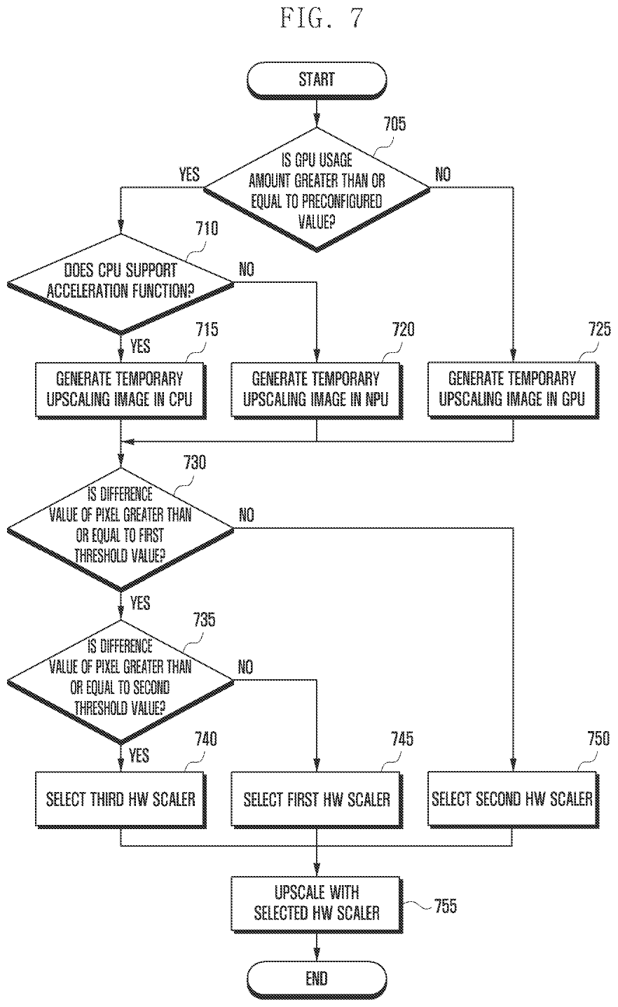

FIG. 7 is a flowchart illustrating a process of selecting a scaler according to an embodiment of the disclosure.

Referring to FIG. 7, the electronic device 101 may compare the usage amount of a GPU (e.g., the GPU 124 of FIG. 3) with a preconfigured value in operation 705. For example, the usage amount of the GPU 124 is the resource occupancy rate of the GPU 124. The usage amount of the GPU may be configured like 60%. When the usage amount of the GPU 124 is greater than or equal to the preconfigured value, the electronic device 101 may determine whether a CPU (e.g., the CPU 125 of FIG. 3) supports a data processing acceleration function in operation 710. For example, a module supporting the data processing acceleration function includes an ARM SCALABLE MATRIX EXTENSION module. When the CPU 125 includes the ARM SCALABLE MATRIX EXTENSION module, the electronic device 101 may determine that the CPU 125 supports the data processing acceleration function. When the CPU 125 supports the data processing acceleration function, the electronic device 101 may generate a temporary upscaling image in the CPU 125 in operation 715. When the CPU 125 does not support a matrix arithmetic processing acceleration function, the electronic device 101 may generate a temporary upscaling image in the NPU (e.g., the NPU 126 of FIG. 3) in operation 720. Alternatively, even when the CPU 125 supports the data processing acceleration function, the electronic device 101 may select a module to generate a temporary upscaling image according to whether the data processing acceleration function is activated. For example, when the data processing acceleration function is activated, the electronic device 101 generates a temporary upscaling image in the CPU 125. When the data processing acceleration function is in an inactive state, the electronic device 101 may generate a temporary upscaling image in the NPU 126. When the usage amount of the GPU 124 is less than the preconfigured value, the electronic device 101 may generate a temporary upscaling image in the GPU 124 in operation 725.

The electronic device 101 may generate a temporary upscaling image by using all included scaler algorithms. For example, when the electronic device 101 includes three scalers and the NPU 126 generates a temporary upscaling image, the NPU 126 generates a first temporary upscaling image with an algorithm of the first scaler, generate a second temporary upscaling image with an algorithm of the second scaler, and generate a third temporary upscaling image with an algorithm of the third scaler. The second scaler may be a scaler for up scaling to a relatively-definition image. For example, the second scaler is a DDI (e.g., the DDI 161 of FIG. 3) scaler. The first scaler may be a scaler for upscaling to a preconfigured high-definition image. For example, the first scaler is an AP scaler. The third scaler may be a scaler for upscaling to a relatively high-definition image. For example, the third scaler includes an AI scaler, an AP1 scaler, or an AP2 scaler. The scaler included in the electronic device 101 may be a hardware scaler. The temporary upscaling image may be an image generated by a software method according to the algorithm of each scaler.

The electronic device 101 may divide the second temporary upscaling image, which is relatively the lowest definition, and the first temporary upscaling image, which is a preconfigured high definition, into a plurality of areas. In addition, the electronic device 101 may obtain a first difference value of pixels in each area and compare the first difference value with a first threshold value in operation 730. For example, the first difference value compared with the first threshold value includes the average value of difference values of all areas, the sum value obtained by summing difference values of a preconfigured number of areas from the area having the largest difference value, or the largest difference value among difference values of all areas.

When the first difference value to be compared is greater than or equal to the first threshold value, the electronic device 101 may compare the first temporary upscaling image with the third temporary upscaling image having the relatively highest definition in the same manner. For example, the electronic device 101 also divides the third temporary upscaling image into a plurality of areas, and obtain the second difference value of the pixel of each area of the third temporary upscaling image and the first temporary upscaling image. In addition, the electronic device 101 may compare the second difference value and the second threshold value in the same manner as the above-described manner in operation 735.

When the second difference value to be compared is greater than or equal to the second threshold value, the electronic device 101 may select the third scaler in operation 740. Alternatively, when the second difference value to be compared is less than the second threshold value, the electronic device 101 may select the first scaler in operation 745. Alternatively, when the first difference value is less than the first threshold value in the above process, the electronic device 101 may select the second scaler in operation 750.

The electronic device 101 may upscale the image with the selected scaler in operation 755. For example, the first scaler and the third scaler are included in the DPU. When the first scaler or the third scaler is selected, the electronic device 101 may control the DPU to upscale the image. In addition, the second scaler may be included in the DDI. When the second scaler is selected, the electronic device 101 may control the DPI to upscale the image. The electronic device 101 may display the image upscaled by the first scaler, the second scaler, or the third scaler on the display 160.

Alternatively, the electronic device 101 may analyze the image based on the trained neural network model and select a scaler according to the analysis result.

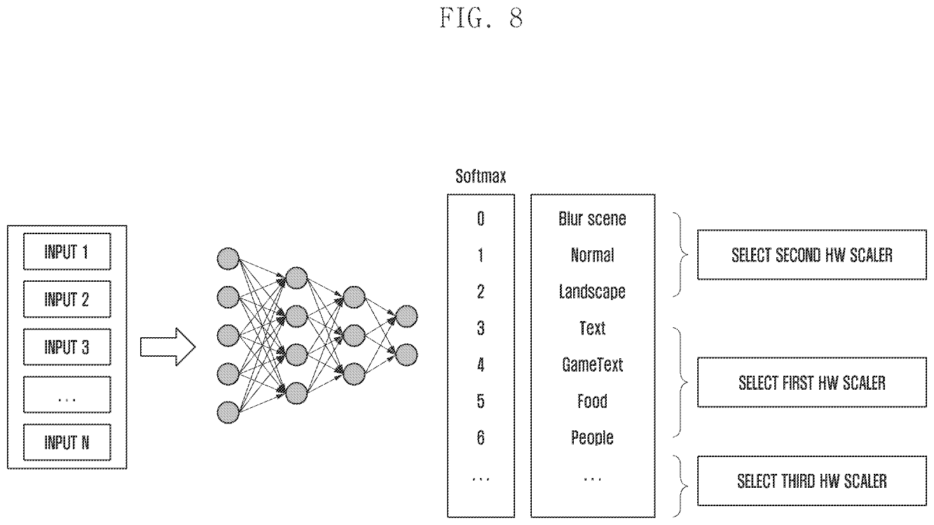

FIG. 8 is a diagram illustrating a process of selecting a scaler by using a trained neural network model according to an embodiment of the disclosure.

Referring to FIG. 8, a trained neural network model for classifying images is illustrated. The electronic device 101 may receive inputs. For example, the inputs to the electronic device 101 are images. The images may include at least one of static images or dynamic images, and dynamic images may include moving images. When a dynamic image is input, the electronic device 101 may receive one input illustrated in FIG. 8 for each scene or each frame of the dynamic image.

The electronic device 101 may input images to the trained neural network model to classify the images. The trained neural network model may classify input images. For example, the trained neural network model classifies input images such as a blur image, a general image, a landscape image, an image including text, an image including game text, a food image, and a human image. The electronic device 101 may select a scaler according to classification by the trained neural network model. For example, when the input image is a blur image, a normal image, or a landscape image, the electronic device 101 selects a second scaler. Alternatively, when the input image is an image including text, an image including game text, or a food image, the electronic device 101 may select the first scaler. Alternatively, when the input image is a human image, the electronic device 101 may select the third scaler. The second scaler converts the input image into a lower quality image than the first scaler and the third scaler, but may reduce power consumption. The first scaler may convert the input image into a preconfigured high-definition image. The third scaler may convert the input image into the highest definition image. The electronic device 101 may classify the input image by using the trained neural network model, select a scaler suitable for the classified result, and upscale the input image, thereby efficiently converting the image.

It should be appreciated that various embodiments of the disclosure and the terms used therein are not intended to limit the technological features set forth herein to particular embodiments and include various changes, equivalents, or replacements for a corresponding embodiment.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it denotes that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
at least one processor;
a display; and
a plurality of scalers including a first scaler and a second scaler,
wherein the at least one processor is configured to:
generate a first temporary upscaling image of an image by using an algorithm of the first scaler that converts an image into an image with a preconfigured high-definition resolution,
generate a second temporary upscaling image of the image by using an algorithm of the second scaler,
identify a difference value of a pixel between the first temporary upscaling image and the second temporary upscaling image,
select one of the first scaler and the second scaler based on the identified difference value and a preconfigured threshold value,
upscale the image by using the selected one scaler, and
control the display to display the upscaled image.

2. The electronic device of claim 1, wherein the at least one processor is further configured to:
divide the first temporary upscaling image and the second temporary upscaling image into preconfigured areas, and
identify a difference value between a pixel included in the divided area of the first temporary up scaling image and a corresponding pixel included in the divided area of the second temporary upscaling image.

3. The electronic device of claim 2, wherein the at least one processor is further configured to:
identify difference values in all the divided areas,
identify an average value of the identified difference values,
select the first scaler in case that the identified average value is greater than or equal to a preconfigured first threshold value, and
select the second scaler in case that the identified average value is less than the preconfigured first threshold value.

4. The electronic device of claim 2, wherein the at least one processor is further configured to:
identify difference values in all the divided areas,
identify a preconfigured number of difference values in descending order among the identified difference values,
identify a sum of the identified preconfigured number of difference values,
select the first scaler in case that the identified sum is greater than or equal to a preconfigured second threshold value, and
select the second scaler in case that the identified sum is less than the preconfigured second threshold value.

5. The electronic device of claim 2, wherein the at least one processor is further configured to:
identify difference values in all the divided areas,
select the first scaler in case that a largest difference value among the identified difference values is greater than or equal to a preconfigured third threshold value, and
select the second scaler in case that the largest difference value is less than the preconfigured third threshold value.

6. The electronic device of claim 1, wherein the at least one processor is further configured to:
include at least one of a central processing unit, a neural network processing unit, and a graphics processing unit, and
generate the first temporary upscaling image and the second temporary upscaling image by using the graphics processing unit in case that a usage amount of the graphics processing unit is less than a preconfigured value.

7. The electronic device of claim 6, wherein the at least one processor is further configured to generate the first temporary upscaling image and the second temporary upscaling image by using the neural network processing unit in case that the usage amount of the graphics processing unit exceeds the preconfigured value.

8. The electronic device of claim 7, wherein the at least one processor is further configured to generate the first temporary upscaling image and the second temporary upscaling image by using the central processing unit in case that the central processing unit includes a data processing acceleration function.

9. The electronic device of claim 1, wherein the at least one processor is further configured to:
upscale the image to a preconfigured high-definition resolution image by using the first scaler in case that the first scaler is selected,
deliver the upscaled image and resolution information of the upscaled image to the display, and
control the display to display the delivered upscaled image based on the upscaled resolution information.

10. The electronic device of claim 1, wherein the at least one processor is further configured to:
deliver the image and resolution information of the image to be upscaled to the display in case that the second scaler is selected,
upscale the image by using the second scaler based on the resolution information of the image to be upscaled, and
control the display to display the upscaled image.

11. The electronic device of claim 1,
wherein the first scaler is included in the at least one processor, and
wherein the second scaler is included in a display driver integrated circuit (IC) (DDI) that drives the display.

12. A control method of an electronic device, the control method comprising:
generating a first temporary upscaling image of an image by using an algorithm of a first scaler that converts an image into an image with a preconfigured high-definition resolution, and generating a second temporary upscaling image of the image by using an algorithm of a second scaler;
identifying a difference value of a pixel between the first temporary upscaling image and the second temporary upscaling image;
selecting one of the first scaler and the second scaler based on the identified difference value and a preconfigured threshold value;
upscaling the image by using the selected one scaler; and
displaying the upscaled image.

13. The control method of claim 12, wherein the identifying of the difference value of a pixel comprises:
dividing the first temporary upscaling image and the second temporary upscaling image into preconfigured areas; and
identifying a difference value between a pixel included in the divided area of the first temporary up scaling image and a corresponding pixel included in the divided area of the second temporary upscaling image.

14. The control method of claim 13, wherein the selecting of one scaler comprises:
identifying difference values in all the divided areas;
identifying average value of the identified difference values;
selecting the first scaler in case that the identified average value is greater than or equal to a preconfigured first threshold value; and
selecting the second scaler in case that the identified average value is less than the preconfigured first threshold value.

15. The control method of claim 13, wherein the selecting of one scaler comprises:
identifying the difference values in all the divided areas;
identifying a preconfigured number of difference values in descending order among the identified difference values;
identifying a sum of the identified preconfigured number of difference values;
selecting the first scaler in case that the identified sum is greater than or equal to a preconfigured second threshold value; and
selecting the second scaler in case that the identified sum is less than the preconfigured second threshold value.

16. The control method of claim 12, wherein the second scaler upscales the image into an image of a lower quality than the image up scales by the first scaler.

17. The control method of claim 16, wherein the second scaler is a hardware scaler.

18. The control method of claim 16, wherein the second scaler is a bilinear scaler, and
wherein the bilinear scaler converts an image into Full High Definition (FHD) image.

19. A non-transitory computer readable medium which, when implemented by an electronic device related to a control method, causes the electronic device to implement operations comprising:
generating a first temporary upscaling image of an image by using an algorithm of a first scaler that converts an image into an image with a preconfigured high-definition resolution, and generating a second temporary upscaling image of the image by using an algorithm of a second scaler;
identifying a difference value of a pixel between the first temporary upscaling image and the second temporary upscaling image;
selecting one of the first scaler and the second scaler based on the identified difference value and a preconfigured threshold value;
upscaling the image by using the selected one scaler; and
displaying the upscaled image.
